(19) United States
(12) Patent Application Publication
(10) Pub. No.: US 2025/0131377 A1
(43) Pub. Date: Apr. 24, 2025

(54) CLASSIFICATION OF HIERARCHICAL PRODUCT PARAMETERS IN A HIERARCHY OF OPERATIONAL FACTORS

(71) Applicant: DevRev, Inc., Palo Alto, CA (US)

(72) Inventors: Shlomi Vaknin, San Jose, CA (US); Dominik Damjakob, Austin, TX (US)

(73) Assignee: DevRev, Inc., Palo Alto, CA (US)

(21) Appl. No.: 18/919,290

(22) Filed: Oct. 17, 2024

Related U.S. Application Data
(60) Provisional application No. 63/544,721, filed on Oct. 18, 2023.

(51) Int. Cl. G06Q 10/101

(52) U.S. Cl. CPC G06Q 10/101

(57) ABSTRACT

Techniques for classifying hierarchical product parameters in a hierarchy of operational factors for an offering operating in a unified platform are disclosed. The technique includes obtaining hierarchical product parameters associated with an offering, retrieving features composed of sub-modules, and determining decisive metrics for the sub-modules. The technique identifies specific sub-modules with metrics exceeding predefined thresholds and classifies them as sub-features. Hierarchical links are established between sub-features and features. The technique includes monitoring the performance and utilization of sub-features and reclassifying sub-features by transforming them into independent features or merging them with parent features. A hierarchical product parameter map is updated based on classifications and reclassifications. The invention provides a flexible, efficient approach for automatically classifying and reclassifying hierarchical product parameters based on operational significance. This allows for more accurate, real-time management of the hierarchy of operational factors, providing valuable insights into product usage, customer needs, and areas for improvement.

### CROSS-REFERENCE TO RELATED APPLICATIONS

The present application claims the benefit of priority to U.S. Provisional Application 63/544,721, filed on Oct. 18, 2023, which is hereby incorporated by reference in its entirety.

### TECHNICAL FIELD

The subject matter of the present invention relates to hierarchy classification, more specifically to a method of identifying sub-features and classifying them under features or classifying sub-features as independent features. The subject matter described herein, in general, relates to classifying a hierarchy of operational factors, and in particular to, classifying hierarchical product parameters in the hierarchy of operational factors for an offering operating in a unified platform.

### BACKGROUND

An offering, such as a product and/or a service, offered by an organization typically encompasses several operational facets to satisfactorily meet diverse user demands. The several operational facets are often facilitated by various resources which operate in distinct environments. Since the several facets are unified in terms of the offering they are deployed to serve, the resources frequently exchange information for efficient and coherent functioning of the several facets. For instance, given a software product, the distinct environments may be a development environment and a user environment. The development environment typically includes tools, frameworks, and systems used by software engineers to design, code, test, and debug the product. On the other hand, the user environment encompasses the platforms, devices, and systems where end-users interact with and utilize the product.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1 illustrates a block diagram of a connected environment, in accordance with an example implementation of the present subject matter.

FIG. 2 illustrates a block diagram of a comprehensive framework comprising hierarchical product parameters for an offering, in accordance with an example implementation of the present subject matter.

FIG. 3 illustrates schematics of a system for classifying hierarchical product parameters, in accordance with an example of the present subject matter.

FIG. 4 illustrates a connected environment comprising four distinct ecosystems related to a common product and/or service built and deployed by an organization, in accordance with an example implementation of the present subject matter.

FIG. 5 illustrates a hierarchy wherein a feature is classified into a sub-feature in accordance with the embodiments of the present subject matter.

FIG. 6A illustrates a hierarchy wherein a feature is classified into a sub-feature/independent feature in accordance with the embodiments of the present subject matter.

FIG. 6B illustrates a hierarchy merge of a parent feature with the sub-feature, in accordance with the embodiments of the present subject matter.

FIG. 7 illustrates a block diagram of a method of generating the sub-feature from a feature in accordance with the embodiments of the present subject matter.

FIG. 8 illustrates a block diagram of a method of determining independent aspects of a sub-feature and transforming it into an independent feature, in accordance with the embodiments of the present subject matter.

FIG. 9 illustrates a block diagram of a method of merging the parent feature with the sub-feature, in accordance with the embodiments of the present subject matter.

FIG. 10 illustrates a block diagram of a method for facilitating classification of hierarchical product parameters in a hierarchy of operational factors, in accordance with an example implementation of the present subject matter.

FIG. 11 illustrates a non-transitory computer-readable medium for facilitating classification of hierarchical product parameters, in accordance with an example of the present subject matter.

FIG. 12 illustrates an illustrative computing system suitable for implementing an embodiment of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

In modern connected computing environments, organizations frequently develop and deploy a wide range of products, services, and solutions across multiple discrete ecosystems. The products, services, and solutions may be collectively referred to as an offering and may encompass any deliverable that an organization may provide to its users or customers. For effective functioning, the offering may interface with a multitude of disparate locations, devices, and entities within the discrete ecosystems. The discrete ecosystems may be inhabited by, not limited thereto, both user-end entities and developer-end entities associated with the offering. The discrete ecosystems, while distinct, may not be entirely isolated as they operate towards a common organizational goal. Therefore, discrete ecosystems may at least be interconnected through shared resources, data, and dependencies, creating a complex web of interactions. Consequently, careful management and orchestration of the interactions between the resources becomes crucial for the successful operation of the offering within the interconnected computing environment.

The discrete ecosystems encompass a diverse set of resources, including hardware infrastructure, software platforms, data storage systems, network components, and the like. The resources may be intricately configured to collectively support the functionality and performance of the offering. As the operations progress in the discrete ecosystems, the diverse set of resources may generate continuous data streams pertaining to various activities or changes occurring within each ecosystem. While the data streams are typically unique to their originating ecosystem, they often reference entities and resources that span across multiple ecosystems.

The data streams may be used by the entities in the connected environment for generating and managing actionable items, for example, incidents, tickets, and issues. The actionable items are commonly associated with various sources and parameters related to the offering. The different sources and parameters may often correspond to specific segments of a comprehensive framework that encompasses the offering and multifaceted aspects of the offering.

The comprehensive framework is composed of hierarchical product parameters for the offering and the different segments of the comprehensive framework relate to one or more hierarchical product parameters. The hierarchical product parameters represent a structured taxonomy of, for example, capabilities, features, microservices, sub-modules related to an offering. Further, a hierarchy comprising the hierarchical product parameters often includes multiple levels of granularity, ranging from high-level categories down to individual feature specifications.

The hierarchical product parameters for the offering are generally classified and categorized within the organization by using either a manual approach or by using rule-based approaches. A system or service software hierarchy is represented as logical modules or subsystems at distinct levels. In system software hierarchy design, a low-level subsystem gives services to its adjacent upper-level subsystems. In any system software hierarchy structure, the lower level provides more specific functionality such as I/O services, transaction, scheduling, security services, etc.; the middle level offers more domain-dependent functions such as business logic and core processing services; and the upper level provides more abstract functionality in the form of user interface such as GUIs, shell programming facilities.

Existing Systems and methods for information retrieval permit users and/or processing entities to access and define synthetic data, synthetic objects, and/or synthetic grouping of information. Synthetic data can define virtual data objects, elements, attributes, groups, and data entities that can be interpreted against data that may be stored physically in information collection. The system and methods for information retrieval can return results from one or more arrays of information based not only on the data stored but also on the virtual data generated from the interpretation of the stored data. The methods of classification or construction of a hierarchy involve grouping the equivalent elements and determining the individual aspects of each element. The attributes of each element are classified into sub-classes of elements based on the dependency of such attributes on the parent element. Generating sub-elements from existing parent elements requires domain expertise and analysis. In existing software platforms that provide multiple products and services, when an issue or customer's need arises, such an issue needs to be processed and assigned to a category manually, or this classification can involve setting up rule-based systems, which tend to follow the rule of ‘IF X happens THEN do Y.’ Manual classification systems are often complicated and cluttered, and support agents struggle to assign a category. After endless hours of going through several running applications, they often assign the ‘Other or miscellaneous’ tag to complete this tedious task faster. Rule-based classification systems are not entirely accurate or efficient and are difficult to maintain and extend. The developer needs to rewrite new rules and actions for new customer demands. Classification with machine learning solves this problem since advanced AI tools can learn, adapt, and determine actions to take without human input. Accurate classification helps businesses store unstructured data, providing many more valuable insights than structured data. Text data explains the ‘why’ behind the numbers so the organization can know specifically what the customers need from its products and services.

Therefore, the manual approach is inherently susceptible to inconsistencies and temporal misalignments with the actual state of a deployed offering. The discrepancy between the manually classified and maintained hierarchical product parameters and the current state of deployments, for example, real-time configuration updates for the resources, may lead to a cascade of operational inefficiencies. For instance, actionable items generated within an enterprise management system may reference outdated resources, potentially misdirecting the reference calls or causing delays in issue resolution. Moreover, if any modifications are made referencing outdated versions of the resources, the inconsistencies may propagate amongst other hierarchical product parameters and resources, affecting a wide range of functions.

The challenge is further aggravated by the rapid pace of modern software development and deployment practices, such as continuous integration and delivery (CI/CD) pipelines. The CI/CD pipelines enable frequent updates and feature releases, which can quickly render manually maintained product hierarchies obsolete. The discrepancies between manually maintained hierarchical product parameters and the actual state of deployments can have far-reaching consequences beyond operational inefficiencies. Such discrepancies may impact strategic decision-making as organizations may base their plans on outdated or inaccurate representations of the offering's capabilities. Additionally, the inconsistencies may affect user experience and satisfaction, as support teams may provide incorrect information or troubleshooting steps based on incorrectly classified hierarchical product parameters.

Further, the conventional rule-based classification approaches are also susceptible to inconsistencies and are not accurate or efficient. The rule-based approaches follow rigid rules for the classification of the hierarchical product parameter. However, such classification approaches are difficult to maintain and extend, requiring developers to constantly rewrite rules and actions to accommodate new customer demands or evolving features of the offering.

The present specification discloses a method of classification of product or service hierarchy, which includes the generation of a Sub-feature (another lower-tier component). In accordance with one of the embodiments, the method for classification of a product or service hierarchy comprises generating Sub-Features from a parent Feature, transforming the Sub-Feature into an independent Feature, and merging the parent Feature properties with the generated Sub-Feature, wherein the Parts discovery module performs the classification of product/service hierarchy. The product and service hierarchies are interchangeably referred to as hierarchy of operational factors. Accordingly, the present subject matter envisages techniques for classifying hierarchical product parameters for an offering in a hierarchy of operational factors.

In accordance with one of the embodiments of the specification, a Part Discovery module performs monitoring of Parts, discovering new Parts from existing hierarchy components by transforming capabilities into new parts and updating an existing parts table (a constituent of a database). The parts are herein interchangeably referred to as hierarchical product parameters. According to one exemplary embodiment, the present subject matter provides systems and methods for monitoring and classifying hierarchical product parameters in a hierarchy of operational factors for the offering operating in a unified platform. The offering may be a product, a service, or a combination of both. Further, the offering may have components operating in distinct ecosystems in a connected computing environment. The distinct ecosystems may be connected through the unified platform where an organization may integrate and manage various aspects of an offering's operations, resources, and processes. The unified platform may be implemented as a Software-as-a-Service (SaaS) platform. The unified platform acts as a central hub unifying the distinct ecosystems within which various components of the offering operate, thereby enabling a holistic approach to generate, classify and maintain accurate hierarchical product parameters. For instance, the unified platform may integrate data from a development ecosystem (e.g., code repositories, build systems), an operations ecosystem (e.g., deployment logs, performance monitoring), and a customer-facing ecosystem (e.g., support tickets, usage analytics).

The hierarchical product parameter may be understood as a parameter associated with a specific level of granularity in the hierarchy of operational factors associated with the offering. The operational factors associated with the offering may span over the plurality of distinct ecosystems operating in relation to the product deployed in the connected environment. For instance, the operational factors may be divided amongst user-end entities and/or developer-end entities responsible for generating them or fixing them.

The hierarchy of operational factors associated with the offering, such as the product or service includes the product or service as the origin entity. The product or service may have one or more capabilities, which are the core unit a user-end entity interacts with and to which revenue can be assigned. Capabilities may have an associated API namespace if delivered as a software product or service. Each capability may comprise an independent set of features, where features define product offerings that can be measurable, observable, upgradable, and potentially monetizable. In an example, the capabilities and/or features may link to backend constructs, termed sub-modules. The sub-modules may be referred to as a unit of deployment and may be an operational factor which composes a feature or capability.

The term “operational factor” thus refers to a component or piece of the hierarchy of operational factors associated with the product and/or service deployed in the connected environment. Exemplary operational factors include a particular capability, feature, microservice, component, and the like. The term “hierarchical product parameter” refers to an operational factor in the hierarchy of operational factors for a particular ecosystem of the connected environment. In an example, for each specific ecosystem, there may be a hierarchy of the operational factors associated with the product and/or service and one or more hierarchical product parameters in relation to the operational factors. In an example, the hierarchical product parameter may be a part of the product or service and the hierarchy of operational factors may be a part hierarchy centered around the product or service. The terms offering, product, and service have been used interchangeably throughout the specification.

In an example implementation, hierarchical product parameters associated with an offering within a hierarchy of operational factors may be obtained. In an example, product parameter seeds may be used for obtaining or generating the hierarchical product parameters. The product parameter seed is a structured data object that encapsulates comprehensive information about the offering, including its capabilities, features, and microservices. The product parameter seed may be a JavaScript Object Notation (JSON), Extensible Markup Language (XML), or Ain't Markup Language (YAML) file. In an example, the hierarchical product parameter may include plurality of capabilities and features associated with the offering. In accordance with one or more implementations of the present subject matter, the method of classifications wherein a feature contains a list of API paths (e.g., rest APIs), wherein the part discovery module uses these API paths to derive the features or sub-features.

Particularly, a feature may be retrieved and analyzed from the obtained hierarchical product parameters. The feature may be composed of multiple sub-modules, which are essentially sets of programming code that can be integrated into microservices. The sub-modules form the building blocks of the feature's functionality. For instance, in a cloud-based project management service, “Task Management” might be a capability, while “Task Assignment” may be a feature within that capability. Further, the sub-modules may include “create task”, “assign task”, “update task status”, “set task priority”, “add task comment”, “create subtask”, and “link related tasks”.

In an aspect of one or more implementations of the present subject matter, the classification of a feature into a sub-feature is implemented through verification and validation of a preset threshold for each aspect of the feature. The threshold is determined based on the contextual, relational, or dynamic analysis of the feature's characteristics. This threshold is used to determine the feature's classification (based on API Paths) as a sub-feature or a parent feature. The threshold is then used to link the feature to a higher-tier part in the product or service hierarchy. This classification helps to determine the importance of a feature and its role in the hierarchy. It also helps to identify which features need to be considered when designing or optimizing a product. For instance, decisive metrics for each sub-module may be determined and evaluated against a set of predefined threshold values. The decisive metrics indicate the operational relevance of each sub-module. In an example, the decisive metrics may be indicative of how often the sub-module is used (usage frequency), number of API requests to the sub-module (API call volume), frequency of errors occurring in the sub-module (error rate), average time taken to process requests (response time), and so on. Further, the set of predefined threshold values may be set based on industry standards or internal benchmarks.

Based on the decisive metrics, a specific sub-module may be identified. The decisive metrics of the specific sub-module metrics may exceed the predefined thresholds, indicating high operational relevance of the identified sub-module. For instance, in the above example of “Task Assignment” feature, the sub module “add task comment” may be identified as the specific sub-module if it exceeds the set of predefined threshold values. The identified sub-module is then classified as a sub-feature, recognizing its distinct operational significance within the feature. For example, the “add task comment” sub-module may be classified as a sub-feature of the “Task Assignment” feature, acknowledging its crucial role in controlling comments for task assignment.

Further, a hierarchical link may be created between the classified sub-feature and its parent feature. For example, in the hierarchy of operational factors, the feature may be “Task Assignment” and the sub-feature may be “add task comment”. In an example implementation, the performance and utilization of the newly classified sub-feature may be monitored. The monitoring may include tracking the sub-feature, in particular, usage patterns of the sub-feature, impact of the sub-feature on the overall performance of the feature, and user feedback and any issues related to sub-feature.

In another aspect of the present specification, the classified sub-feature can further be classified into an independent feature or independent sub-feature through validation of the independent aspects of such classified sub-feature. This new independent feature or independent sub-feature is further mapped to the upper hierarchy element (Capability) of the product or service of the existing present unified platform. In the present example implementation, based on the monitoring, the sub-feature may be re-classified by transforming the sub-feature into an independent feature. If the sub-feature grows in importance and complexity, it may be elevated to the independent feature. For example, the sub-feature may be transformed into the independent feature if its functionality expands to cover broader aspects of the feature across the entire application. In another example, the sub-feature may be transformed into the independent feature if it is used frequently independent of the parent feature. In yet another example, the sub-feature may be transformed into the independent feature if it requires dedicated development and maintenance resources.

In another aspect of the present specification, the classified sub-feature can be merged into the parent feature through validation of independent aspects of such classified sub-feature, and this merge operation will combine the properties of the parent feature with the sub-feature, and the sub-feature is extended with additional independent properties of the parent feature. In the present another aspect, based on the monitoring, the sub-feature may be re-classified by merging the sub-feature with the parent feature. For example, the sub-feature may be merged with the parent feature if its functionality becomes more tightly integrated with the assigned task. In another example, the sub-feature may be merged with the parent feature if it is rarely used independently of the parent feature. In yet another example, the sub-feature may be merged with the parent feature if maintaining it as a separate sub-feature adds unnecessary complexity.

After any classification or reclassification, an interrelated event hierarchy, also referred herein as hierarchical product parameter map, may be updated to reflect the changes in the hierarchical product parameters. In an example, the hierarchical product parameters map may be updated upon detecting any change or relevant information on an existing hierarchical product parameter.

The present subject matter thus provides a flexible and efficient approach for automatically classifying and re-classifying hierarchical product parameters based on their operational significance and updating the hierarchy of operational factors while maintaining data integrity and relationships. The present subject matter enables the automatic generation of sub-features from parent features, as well as transforming the sub-features into independent features or merging them with the parent features. The dynamic approach of the present invention allows for a more accurate and real-time management of the hierarchy of operational factors for the offering.

By accurately classifying and organizing the features and sub-features, the present subject matter provides valuable insights into product usage, customer needs, and potential areas for improvement or new feature development for the offering. The accurate classification of features and sub-features enables support teams to more quickly identify and resolve customer issues by linking them to specific hierarchical product parameters of the product or service. The automated nature of the classification process makes it easier to scale across multiple products and services, and to maintain the hierarchy with the evolution of the offerings over time. Further, the classification method integrates seamlessly with the existing unified platform, allowing for better coordination between development, operations, and customer-facing teams. These technical advantages collectively contribute to a more efficient, reliable, and accurate system for classifying the hierarchy of operational factors for the offering, addressing key challenges faced in conventional systems.

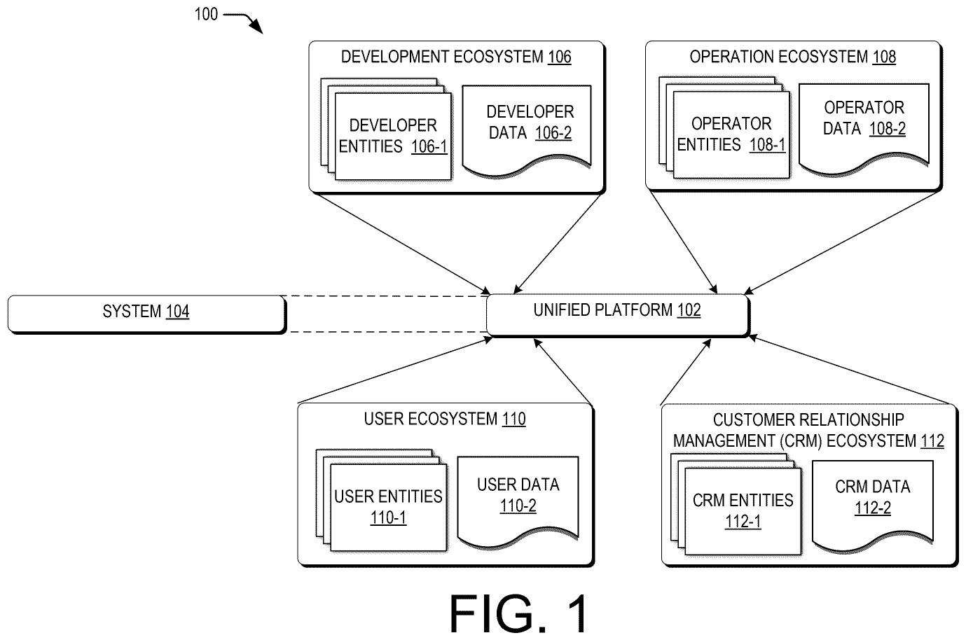

The present subject matter is further described with reference to FIGS. 1-7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 provides a block diagram of a connected environment 100, in accordance with an example implementation of the present subject matter. The connected environment 100 represents a comprehensive network of interconnected systems, devices, and services that collectively support the operation and management of an offering. An offering may be onboarded with a unified platform 102 and the unified platform 102 may be responsible for supporting and maintaining distinct functions in relation to the offering. The unified platform 102 may incorporate technologies such as cloud computing, containerization, microservices architecture, and the like.

In an example, the unified platform 102 may be hosted by a system 104. The system 104 may include any type of equipment that may be used to implement, operate, or interface with the unified platform 102. The system 104 may be, for example, workstations, personal computers, mobile devices, servers, hosts, nodes, or remote computing terminals.

The unified platform 102 may connect various discrete ecosystems, each of which may focus on different specific aspects of the offering, such as development, deployment, operation, and user interaction. Event hierarchies of developer entities/systems, user entities/systems, CRM/Revenue-based entities/systems, and admin/operator entities/systems are described in FIG. 1, as an example. The operation of the unified platform 102 involves analysis of large amounts of data streams captured from the distinct ecosystems to identify events occurring at the distinct ecosystems for processing by the unified platform 102. The unified platform 102 may implement autonomous processing of the events to generate items of interest to one or more entities operating in distinct ecosystems.

The discrete ecosystems, while distinct in their primary functions, may be intricately linked through the unified platform 102. In an example, the discrete ecosystems may include a development ecosystem 106, an operation ecosystem 108, a user ecosystem 110, and a customer relationship management (CRM) ecosystem 112. The discrete ecosystems, while operating independently to some degree, are interconnected through the unified platform 102, allowing for a holistic approach to managing the offering's lifecycle and ensuring consistent performance and user experience across all aspects of the offering. The system 104 hosting the unified platform 102 may be connected with different computing devices hosted across the connected environment 100 through a network (not shown).

The system 104 may be communicatively coupled to computing devices (not shown) associated with each of the discrete ecosystems either through a direct communication link, or through multiple communication links of the network. The network may be a wireless or a wired network, or a combination thereof. The network may be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the network includes various network entities, such as gateways and routers; however, such details have been omitted to maintain the brevity of the description.

Any number or type of data streams generated by the distinct ecosystems may be acted upon by embodiments of the present subject matter. The development ecosystem 106 may inhabit a plurality of developer entities 106-1 and may generate data streams comprising developer data 106-2. The development ecosystem 106 may be related to aspects of building the offering and various components related to the offering. For example, the development ecosystem 106 may encompass various tools, platforms, and processes used in the creation and maintenance of the offering. The tools and platforms may include integrated development environments (IDEs), version control systems, continuous integration/continuous deployment (CI/CD) pipelines, code review tools, and testing frameworks. The developer entities 106-1 may represent individual software engineers, development teams, or automated systems involved in the coding, testing, and deployment processes. Further, the developer data 106-2 generated in the data streams originating from the developer entities may include code commits, pull requests, build logs, test results, code coverage reports, and performance profiling data. The developer data 106-2 may provide information regarding the evolution of the offering, identifying potential issues early in the development cycle, and maintaining code quality.

Further, the operation ecosystem 108 may inhabit a plurality of operation entities 108-1 and may generate data streams comprising operation data 108-2. The operation ecosystem 108 may be related to aspects of deployment, monitoring, updating, and maintenance of the offering in the connected environment 100. For example, the operation ecosystem 108 may include tools, platforms, and processes used in infrastructure management (Cloud platforms, on-premises servers, containerization technologies (e.g., Docker, Kubernetes), and virtual machines), monitoring and alerting systems (Prometheus, Grafana, Nagios, Datadog, and the like), log management solutions (Centralized logging systems such as ELK (Elasticsearch, Logstash, Kibana) stack or Splunk), performance optimization tools, and the like. The operation entities 108-1 may represent individual system administrators, DevOps engineers, and site reliability engineers. Further, the operation data 108-2 generated in the data streams originating from the operation entities may include server logs, performance metrics, resource utilization statistics, container orchestration metrics, CDN (Content Delivery Network) edge server performance, and incident reports. The operation data 106-2 may assist in determining the reliability, scalability, and efficiency of the offering in real-world usage scenarios.

The user ecosystem 110 may inhabit a plurality of user entities 110-1 and may generate data streams comprising user data 110-2. The user ecosystem 110 may be related to aspects of interaction of end-users with the offering. For example, the user ecosystem 110 may include various client devices, operating systems, network conditions, and the like. The user entities 110-1 may represent the end-users. Further, the user data 110-2 generated in the data streams originating from the user entities 110-1 may include usage patterns, feature adoption rates, user feedback, and error reports. The user data 110-2 may provide information useful for understanding user behaviour, identifying areas for improvement, and guiding future development priorities.

The CRM ecosystem 112 may inhabit a plurality of CRM entities 112-1 and may generate data streams comprising CRM data 112-2. The CRM ecosystem 112 may be related to aspects of managing relationships and interactions of customers with the offering. For example, the CRM ecosystem 112 may include customer support platforms, sales management tools, marketing automation platforms, chatbot systems, user journey mapping tools, and the like. The CRM entities 112-1 may include sales representatives, technical support engineers, feedback analysts, service chatbots, Artificial Intelligence (AI) assistants, and the like. Further, the CRM data 112-2 generated in the data streams originating from the CRM entities 112-1 may include customer inquiries, support tickets, sales data, and sentiment analysis metrics. The CRM data 112-2 may provide information useful for understanding customer needs, improving support processes, and identifying upselling or cross-selling opportunities.

The unified platform 102 hosted by the system 104 is thus configured to interface with diverse data sources, such as the various entities in the discrete ecosystems (the development ecosystem 106, the operation ecosystem 108, the user ecosystem 110, and the CRM ecosystem 112), across the connected environment 100. The unified platform 102 thus allows for extracting relevant information from heterogeneous data streams originating from the various entities in the discrete ecosystems of the connected environment 100. The system 104 may be configured to integrate the heterogeneous data from the various discrete ecosystems and understand complex relationships and contexts within the heterogenous data, potentially uncovering insights that might not be apparent through the traditional data analysis techniques. The context and insights may alert towards the requirement of certain modifications in one or more of the different aspects of the offering. Further, the heterogenous data and the derived insights and context may be used to generate product parameter seeds. The product parameter seeds may be executable to generate or update one or more aspects related to the offering. The system 104 may also classify the generated or updated aspects related to the offering. The present subject matter outlines an application of the inventive method for the Software-as-a-Service (Saas) industry, but it is not limited to this industry.

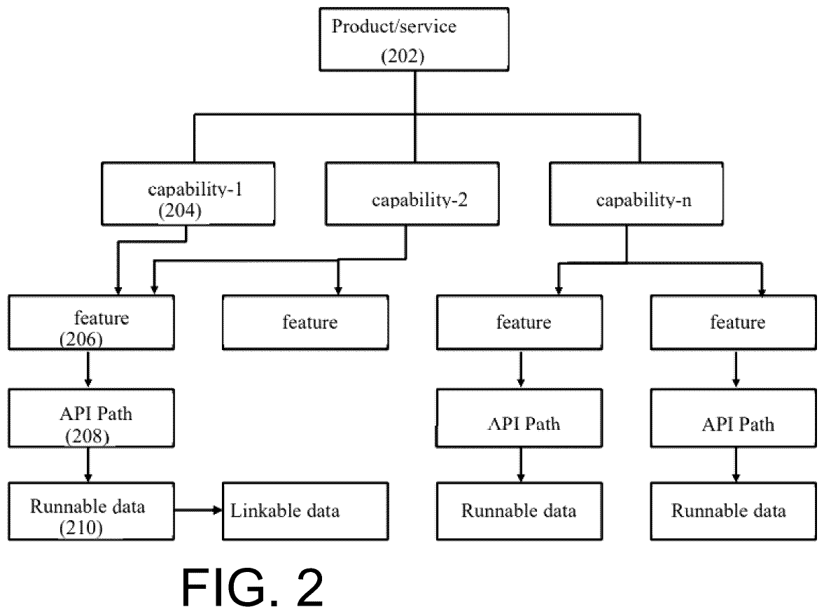

FIG. 2 illustrates a block diagram of a comprehensive framework comprising hierarchical product parameters for an offering, in accordance with an example implementation of the present subject matter. The hierarchical product parameters correspond to different parts in a hierarchy of a product/service (the offering).

The comprehensive framework standardizes a hierarchy of product parameters ensuring consistency and coordination across all entities and data from the discrete ecosystems in the unified platform 102 (as discussed with reference to FIG. 1). Each element in the hierarchy may be referred to as a hierarchical product parameter. The structure and specific product parameters of the hierarchy may vary depending on a type of the offering 200. Though the description here focuses on software-based offerings, the comprehensive framework may be adapted for other products or services.

The hierarchy of the present unified system is centered around the ‘Product’ or ‘Service,’ which is the primary entity to which all Parts are related and branched. A Product or Service 202 is defined as a set of Capabilities 204, the lower level in the product or service hierarchy where revenue can be assigned, a market category is created or attributed, and it is the core unit with which the consumer interacts. A ‘Capability’ 204 is defined with an independent set of Features 206 that is prominent enough to define a product offering that can be measurable, observable, upgradable, and potentially monetizable. Capabilities 206 can have configurable items classified as Feature 208. Feature 208 is specific to Capability 206 and can be enabled, metered, or tracked for usage. An effortless way to think about Feature 208 provides entities and associated actions and/or toggles that can be performed (e.g., create, update, enable, disable) on the entities being provided. Capabilities may have an API namespace if delivered as a software product or service and can have associated service level agreements (SLA). Features comprise a set of API paths 210, wherein an API path can be a runnable interface 212 or linkable interface with which the customer interacts. In the present hierarchy, each Capability, each Feature, and each Sub-Feature is a ‘Part’ component

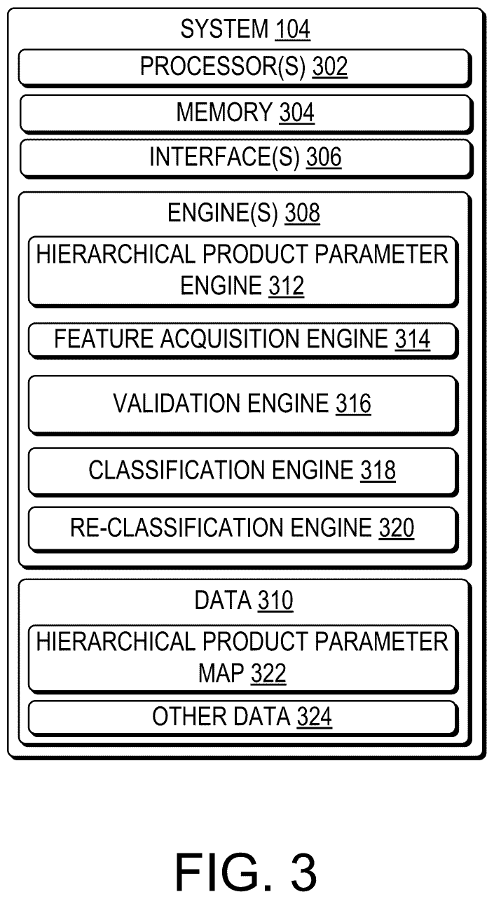

FIG. 3 illustrates schematics of a system for classifying hierarchical product parameters in a hierarchy of operational factors, in accordance with an example of the present subject matter. As already described, the system 104 may host the unified platform 102 and the unified platform 102 may communicate with the discrete ecosystems in the connected environment 100. FIG. 3 illustrates additional aspects of the invention, with reference numbers and elements that may be drawn from FIGS. 1 and 2 as explained above. Similar or identical components may retain the same reference numbers across figures for consistency.

The system 104 may include a processor(s) 302 to run at least one operating system and other applications and services. The system 104 may further include a memory 304 coupled to the processor(s) 302, interface(s) 306, engine(s) 308, and data 310.

The processor(s) 302, amongst other capabilities, may be configured to fetch and execute computer-readable instructions stored in the memory. The processor(s) 302 may be implemented as one or more microprocessors, microcomputers, microcontrollers, digital signal processors, central processing units, state machines, logic circuitries, and/or any devices that manipulate signals based on operational instructions. For instance, the processor(s) 302 may include specialized AI accelerators or Graphic Programming Units (GPUs) optimized for machine learning tasks. The functions of the various elements shown in the figure, including any functional blocks labelled as “processor(s)” or “processing unit”, may be provided through the use of dedicated hardware as well as hardware capable of executing machine readable instructions.

When provided by the processor(s) 302, the functions may be provided by a single dedicated processor, by a single shared processor, or by a plurality of individual processors, some of which may be shared. Moreover, explicit use of the term “processor(s)” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. For example, the system 104 may utilize FPGAs for real-time data processing and ASICs for specific, high-performance tasks like encryption or data compression. Other hardware, conventional and/or custom, may also be included. The processor(s) 302 may include routines, programs, objects, components, data structures, and the like, which perform particular tasks or implement particular abstract data types. The processor(s) 302 may further include modules that supplement applications on the system 104, for example, modules of an operating system. Further, the processor(s) 302 may be implemented in hardware, instructions executed by a processing unit, or by a combination thereof.

The memory 304 may be coupled to the processor(s) 302 and may, among other capabilities, provide data and instructions for performing different functions. The memory 304 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 304 may store the information received and in possession of the system 104 as data 310.

The interface(s) 306 may include a variety of machine-readable instructions-based interfaces and hardware interfaces that allow the system 104 to interact with different components, such as the processor(s) 302, the memory 304, the engines 308, and the data 310. Further, the interface(s) 306 may enable the system 104 to communicate with computing devices, for example, the computing devices in the discrete ecosystems communicate with the system 104, web servers, and external repositories. The interface(s) 306 may facilitate multiple communications within a wide variety of networks and protocol types, including wireless networks, wireless Local Area Network (WLAN), RAN, satellite-based network, and the like. For instance, the interface(s) 306 may support protocols such as Hyper Text Transfer Protocol Secure (HTTPS), Message Queuing Telemtry Transport (MQTT), and Remote Procedure Calls (RPCs).

The engine(s) 308 may be implemented as a combination of hardware and firmware or software. In examples described herein, such combinations of hardware and firmware may be implemented in several different ways. For example, the firmware for the engine(s) 308 may be processor executable instructions stored on a non-transitory machine-readable storage medium and the hardware for the engine(s) 308 may include a processing resource (for example, implemented as either a single processor or a combination of multiple processors), to execute such instructions. The engine(s) 308 may be provided to enable the processes of a part discovery module automating the classification of features into sub-features to classify a hierarchical product parameter in a hierarchy of operational factors.

In the present examples, the machine-readable storage medium may store instructions that, when executed by the processor(s) 302, implement the functionalities of the engine(s) 308. In such examples, the system 104 may include the machine-readable storage medium storing the instructions and the processor(s) 302 to execute the instructions. In other examples of the present subject matter, the machine-readable storage medium may be located at a different location but accessible to the system 104 and the processor(s) 302. The engine(s) 308 may include a hierarchical product parameter engine 312, a feature acquisition engine 314, a validation engine 316, a classification engine 318, and a re-classification engine 320 coupled with each other.

The system 104 may further include data 310, that serves, amongst other things, as a repository for storing data that may be fetched, processed, received, or generated by the engine(s) 308. The data 310 may include hierarchical product map 322, and other data 324. In an example, the data 310 may be stored in the memory 304.

In an example implementation, the hierarchical product parameter engine 312 may obtain hierarchical product parameters associated with an offering within a hierarchy of operational factors. The hierarchical product parameters may include multiple capabilities and features as a sub-unit of the capabilities. In an example, the hierarchical product parameters may be generated by a product parameter seed. The product parameter seed may be executable to obtain a hierarchical product parameter for the offering operating in the unified platform based on a data retrieval signal. The data retrieval signal may be received from an entity operating in association with the unified platform 102 in the connected environment 100. The entity may be associated with the offering 200 and may be one of the developer entities 106-1, the operator entities 106-2, the user entities 106-3, and the CRM entities 106-4. For example, a developer entity 106-1 may send a data retrieval signal to gather information about recent code commits and associated performance metrics.

On obtaining the hierarchical product parameters, the feature acquisition engine 314 retrieves a feature associated with the offering. The feature acquisition engine 314 may access the feature and fetch information about the feature. The information may be related to usage, functionality, and composition of the feature. The feature is composed of multiple smaller, modular components, referred to as sub-modules. Each sub-module amongst the plurality of sub-modules represents a set of programming code integrable in a microservice for performing a capability. Further, each sub-module contributes to the overall functionality of the feature, which in turn supports the higher-level capability. Each of the sub-modules may represent a distinct piece of functionality within the larger feature. The system 104 design allows for flexible, scalable, and maintainable software architecture. Each sub-module can be developed, tested, and deployed independently, while still working together to provide the functionality of the feature. This approach aligns with modern software development practices, especially in cloud-based and distributed systems.

In an example implementation, the validation engine 316 may determine and monitor decisive metrics of the sub-modules. The validation engine 316 may continuously track the performance of each sub-module. The decisive metrics indicate the operational relevance of each sub-module. In an example, the decisive metrics are quantitative or qualitative measures used to evaluate the importance, performance, or relevance of a sub-module. The decisive metrics are considered “decisive” because they are crucial in determining the value and effectiveness of the sub-module.

In an example, the decisive metrics may include one or more of a usage frequency, a functional cohesion, an inter-component coupling, and an operational distinctiveness. The usage frequency may be referred to as a rate at which the sub-module is utilized within the system. It quantifies the rate of utilization, which may help in identifying which sub-modules are most critical or frequently accessed. The functional cohesion may be referred to as the degree to which elements within the sub-module work together to accomplish a specific, well-defined task. High functional cohesion indicates that the sub-module's components are tightly focused on performing a single, clear function. The inter-component coupling may be referred to as a level of interdependence between different sub-modules. Further, the operational distinctiveness is indicative of the uniqueness of the sub-module's function compared to other sub-modules of the plurality of sub-modules.

In an example implementation, the validation engine 316 may evaluate the decisive metrics of each sub-module against a set of predefined threshold values. In an example, the system 104 may establish benchmark values for each decisive metric. In an example, the predefined threshold values may be determined through at least one of a contextual, relational, and dynamic analysis of the hierarchical product parameters.

In the contextual analysis, the hierarchical product parameters may be examined within their specific context or environment. It takes into account factors such as the overall purpose of the offering, the organization in which it operates, and the specific needs of users. Further, the contextual analysis ensures that the threshold values are relevant and appropriate for the particular use case or domain of the offering. The relational analysis may be focused on how different hierarchical product parameters relate to each other within the system. It may examine the interconnections, dependencies, and interactions between various hierarchical product parameters. Relational analysis helps in setting threshold values that reflect the relative importance and impact of different parameters within the overall hierarchy of the operational factors. Further, the dynamic analysis may include analyzing the behavior of the hierarchical product parameters over time or under different conditions. It may consider how the hierarchical product parameters change, evolve, or perform in various scenarios. Dynamic analysis allows for threshold values that can adapt to changing circumstances or usage patterns of the offerings.

By using one or more of the analysis methods, i.e., the contextual analysis, the relational analysis, and the dynamic analysis, the system 104 may ensure that the threshold values used for classifying sub-modules are well-informed, appropriate, and effective in capturing the true operational significance of each hierarchical product parameter within the hierarchy of operational factors of the offering.

The decisive metrics of each sub-module are compared with the set of predefined threshold values to validate an operational relevance, i.e., to determine if a sub-module is operationally relevant. The operational relevance may indicate the degree to which a sub-module provides relevant contribution to the functionality of the feature. For instance, a “spell check” sub-module in a word processing feature that is rarely used and consumes significant resources might be deemed to be less operationally relevant. Conversely, a “file encryption” sub-module in a secure file sharing feature that is frequently used and performs efficiently would likely be highly operationally relevant. In an example, a sub-module that consistently meets or exceeds the predefined threshold values is operationally relevant.

The validation engine 316 allows for data-driven decision making about the composition and optimization of features. For example, sub-modules that are found to have low operational relevance may be considered for removal, optimization, or replacement, while those with high operational relevance may receive more development resources or be considered for expansion. The continuous monitoring and evaluation of the sub-modules provides data-driven insights into the operational relevance of the sub-modules. In an example, the system 104 can automatically flag sub-modules that are underperforming or are particularly valuable, allowing developers to focus their efforts where they will have the most impact.

Based on the validation, the validation engine 316 may identify a specific sub-module from the sub-modules associated with the feature. The specific sub-module may have decisive metrics exceeding the predefined threshold values. For example, the predefined threshold values may represent the minimum levels at which a sub-module is considered significant enough to be identified as the specific sub-module.

The classification engine 318 may then classify the identified specific sub-module into a sub-feature. Once a specific sub-module has been identified (based on its decisive metrics exceeding predefined threshold values), it is then categorized or labeled as a “sub-feature”. Such a classification involves recognizing that the identified sub-module has a special significance within the feature. In an example, the sub-feature may be a distinct subset of the feature, i.e., the sub-feature has unique characteristics or functionality that may clearly differentiate it from other sub-modules within the feature. The sub-feature also plays an important role in the overall functionality of the feature. It contributes meaningfully to how the feature operates or performs its intended function. Further, the sub-feature is still a part of the larger feature, and it doesn't stand entirely on its own.

The classification technique is important because it allows for more granular organization and management of the offering. By classifying the sub-modules as sub-features, the system can better manage, monitor, and optimize the important sub-modules, while still maintaining their relationship to the parent feature. Further, by identifying sub-features, the system may be able to better understand the internal structure of features and may provide more detailed insights into how different parts of a product or service are used. This, in turn, may enable more precise tracking, monitoring, and management of hierarchical product parameters.

In an example, the classification engine 318 may establish a hierarchical link between the classified sub-feature and the feature. For instance, a structured relationship may be created within the product or service hierarchy between a newly classified sub-feature and its parent feature. The feature represents a higher-level component, while the sub-feature is a more specific, lower-level component derived from the feature. The hierarchical link establishes a parent-child relationship where the feature is the parent and the sub-feature is the child. This relationship indicates that the sub-feature is a subset or specialized aspect of the broader feature. In an example, the system 104 may update a hierarchical product parameter map to reflect the new relationship, i.e., established hierarchical link between the classified sub-feature and the feature.

The hierarchical link may enable traceability between different levels of the hierarchy of operational factors for the offering. For instance, users may be able to navigate from the sub-feature up to its parent feature, understanding the context and broader functionality it belongs to. In an example, the hierarchical link may be represented visually, in user interfaces or documentation, illustrating how the sub-feature fits within the larger feature context. Accordingly, by establishing the hierarchical link, the system 104 creates a clear, structured relationship between the newly identified sub-feature and its parent feature, enhancing the overall organization and understanding of the product or service architecture.

In an example implementation, the system 104 may maintain flexibility, allowing for future reclassifications or reorganizations of the hierarchy, as needed. The re-classification engine 320 monitors the performance and utilization of the sub-features. In an example, the re-classification engine 320 tracks and evaluates how the newly classified sub-feature is functioning and being used within the system 104. For instance, the re-classification engine 320 may determine a performance metric indicating how well the sub-feature is executing its intended functions. In an example, the performance metric may include response time (indicative of how quickly the sub-feature processes requests), throughput, error rates (frequency of errors or failures), and resource consumption (consumption of CPU, memory, and network).

In another example, the re-classification engine 320 may determine a utilization metric indicating how frequently and in what ways the sub-feature is being used. In an example, the utilization metric may include usage frequency (indicative of how often the sub-feature is invoked), user engagement (interaction of users with the sub-feature), API call volume (number and types of API calls to the sub-feature), and usage patterns (indicative of when and how the sub-feature is being used).

By monitoring the performance metric and the utilization metric, the system 104 may verify if the decision to classify the sub-module as a sub-feature has been appropriate. High utilization and good performance may confirm the importance of the classified sub-feature. In an example, continuous monitoring of the sub-feature may reveal areas where the sub-feature could be improved or optimized.

The monitoring of the sub-features may be essential for maintaining the dynamic and responsive nature of the classification system, thereby allowing it to evolve based on real-world usage and performance data. Further, the re-classification capability allows the hierarchy of operational factors to evolve dynamically based on usage patterns, feature importance, or strategic decisions, ensuring that the offering structure remains optimized and relevant over time.

In an example implementation, based on the monitoring of the performance and utilization of the sub-feature, the re-classification engine 320 may transform the sub-feature into an independent feature. The transformation may involve elevating the status of a sub-feature to that of an independent feature. The sub-feature may be transformed into an independent feature if it shows high importance and independence. In an example, the transformation into an independent feature may include reassessing the sub-feature's role and importance within the overall product hierarchy.

The re-classification engine 320 may analyze the sub-feature to identify independent aspects, i.e., characteristics or functionalities that are self-contained and do not heavily depend on the parent feature. In an example, the analysis may involve examining the sub-feature's API calls, data structures, functionality, and how it interacts with other hierarchical product parameters of the system. The re-classification engine 320 assesses whether the sub-feature has enough standalone value to exist as its own feature. Once the independent aspects are identified, the system validates them against a pre-defined criterion. This validation may include checking if the independent aspects meet threshold requirements for functionality, usage, or importance. If the validation is successful, the sub-feature may then be transformed into an independent feature. In an example, the transformation may include one or more of restructuring the code or architecture to remove dependencies on the parent feature and creating new interfaces or API endpoints specific to this new independent feature.

After the transformation, the independent feature needs to be properly placed within the hierarchy of operational factors of the offering. The re-classification engine 320 links this new independent feature to a higher-tier parameter in the hierarchy, such as a capability or another appropriate level. The linking of the new independent feature to the higher-tier parameter ensures that the new independent feature is correctly positioned within the overall hierarchy structure, making it discoverable and usable as a standalone entity. Further, the system may dynamically evolve its feature hierarchy, promoting sub-features to independent feature status on demonstrating sufficient independence and importance. This can lead to a more flexible and granular structure of the offering, thereby improving modularity, reusability, and overall system organization.

In another example implementation, based on the monitoring of the performance and utilization of the sub-feature, the re-classification engine 320 may merge the sub-feature with the parent feature to create a consolidated feature. The consolidated feature may be created by combining the sub-feature back into its parent feature. This merger may result in a single, more comprehensive feature that incorporates the functionality of both the parent feature and the sub-feature. In an example, the sub-feature may be merged with the parent feature if it shows low utilization or high coupling. The sub-feature may also be merged with the parent feature if the distinction between the feature and sub-feature becomes less relevant over time. Further, the merging may take place in scenarios where the sub-feature's functionality is seen as integral to the parent feature rather than a separate entity.

The re-classification engine 320 may analyze the sub-feature to determine independent aspects of the sub-feature, i.e., identify its unique characteristics, functionalities, or properties that distinguish it from the parent feature. The analysis may involve examining the sub-feature's API calls, data structures, functionality, and interaction of the sub-feature with other hierarchical product parameters of the system. Once the independent aspects are determined, the system validates them against a pre-defined criterion. This validation may include checking if the independent aspects meet threshold requirements for functionality, usage, or importance. Based on the validation of the determined independent aspects, the re-classification engine 320 may combine the properties of the parent feature with those of the sub-feature. In an example, the merging may include identifying the unique properties of the parent feature that are not present in the sub-feature and integrating the unique properties into the sub-feature's structure and functionality. Further, the system may ensure that the merged result, i.e., the consolidated feature maintains the independent aspects of the sub-feature while incorporating the relevant aspects of the parent feature.

The consolidated feature allows the system to optimize the feature's hierarchy by consolidating related functionalities. The optimization may lead to a more streamlined structure of the offering, thereby reducing redundancy, improving feature cohesion, and offering more robust capabilities to users. In addition, the validation step ensures that the consolidation may occur only when it is meaningful from a functional and architectural perspective, preserving the valuable independent aspects of the sub-feature while enhancing it with properties from the parent feature.

With the occurrence of re-classification, the re-classification engine 320 may modify or update the hierarchical product parameter map to reflect the changes. Keeping the hierarchical product parameter map updated ensures that it accurately reflects the current state of the offering's structure. As the offering evolves and the hierarchical product parameters are continuously evaluated, classified, and re-classified, the hierarchical product parameter map may be regularly updated to maintain its accuracy and relevance. Additionally, by updating the hierarchical product parameter map based on classification and reclassification, the system 104 ensures that there is always an accurate, real-time representation of the offering's structure, which is vital for effective management and development of the offering in the unified platform.

The present subject matter thus provides a flexible and efficient approach for automatically classifying and re-classifying hierarchical product parameters based on their operational significance and updating the hierarchy of operational factors while maintaining data integrity and relationships. The dynamic approach of the present invention allows for a more accurate and real-time management of the hierarchy of operational factors for the offering. Further, the decisive metrics in the present subject matter are crucial for evaluating the design, efficiency, and importance of sub-modules within the larger system. The decisive metrics help in making decisions about classification, reclassification, and potential restructuring of the system's hierarchical product parameters to optimize performance and maintainability.

By accurately classifying and organizing the features and sub-features, the present subject matter provides valuable insights into product usage, customer needs, and potential areas for improvement or new feature development for the offering. The accurate classification of features and sub-features enables support teams to more quickly identify and resolve customer issues by linking them to specific hierarchical product parameters of the product or service. Additionally, the classification method integrates seamlessly with the existing unified platform, allowing for better coordination between development, operations, and customer-facing teams. These technical advantages collectively contribute to a more efficient, reliable, and accurate system for classifying the hierarchy of operational factors for the offering.

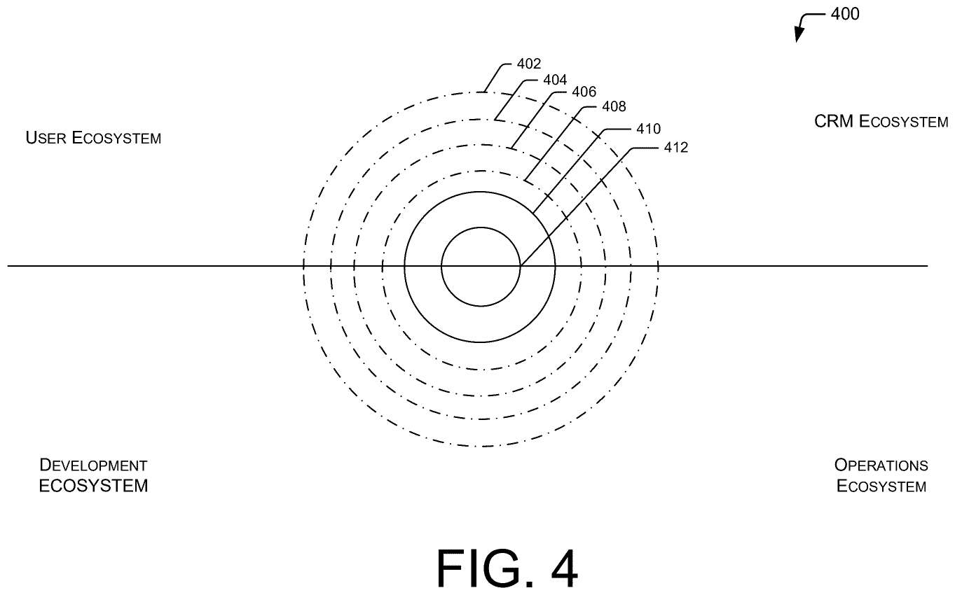

As is evident, central to various embodiments of the present subject matter are the products operating in distinct ecosystems and events generated at each distinct ecosystem. FIG. 4 provides a connected environment 400 comprising four distinct ecosystems related to a common product and/or service built and deployed by an organization. While four specific ecosystems are shown in the current embodiment figures, it is noted that other and additional ecosystems may be implemented for additional embodiments. Therefore, the scope of the invention is not to be limited just to the specific ecosystems illustrated in the figures but may encompass other ecosystems as well.

For the sake of explanation, FIG. 4 is divided into four quadrants, where each quadrant represents a different ecosystem. The lowest two quadrants correspond to developer-end ecosystems. The lower left quadrant represents a development ecosystem. The development ecosystem inhabits entities used by and interfaced with activities that are used to “build” a software product. The lower right quadrant represents an operations ecosystem. The operations ecosystem inhabits entities used by and interfaced with activities that are used to enable “operation” of the product. The upper two quadrants correspond to user-end ecosystems. The upper right quadrant represents a CRM ecosystem. The CRM ecosystem inhabits entities responsible for providing “support” to the operation of the software product. The upper left quadrant represents the user/customer ecosystem, which inhabits entities responsible for actual working on the software product.

The four quadrants are illustrated to include a set of concentric rings (depicted with dotted lines) which represent stages for triaging for events generated by the discrete ecosystems. A first ring 402 encompasses the greatest area of the connected environment 400, and represents event data generated by the discrete ecosystems. From the first ring 402, the events may be triaged using a triaging logic to form a second ring 404 representing incidents, which correspond to the next stage from events. A third ring 406 corresponds to the tickets, which is the next stage from the incidents. A fourth ring 408 corresponds to the issues, which is the next stage from the tickets. FIG. 4 shows even more rings (shown with solid lines) within these above-described rings, which relate to granular aspects of the products created by the developers. These granular aspects of the product may be referred to as operational factors for the product. The solid concentric rings, as depicted, may represent a hierarchy of operational factors. For example, FIG. 4 shows a first solid ring 410 corresponding to the granularity of a “component” and/or “feature”. Within the first solid ring 410, the next level of granularity is a second solid ring 412 at the granularity of a “service”, “microservice”, and/or “capability”.

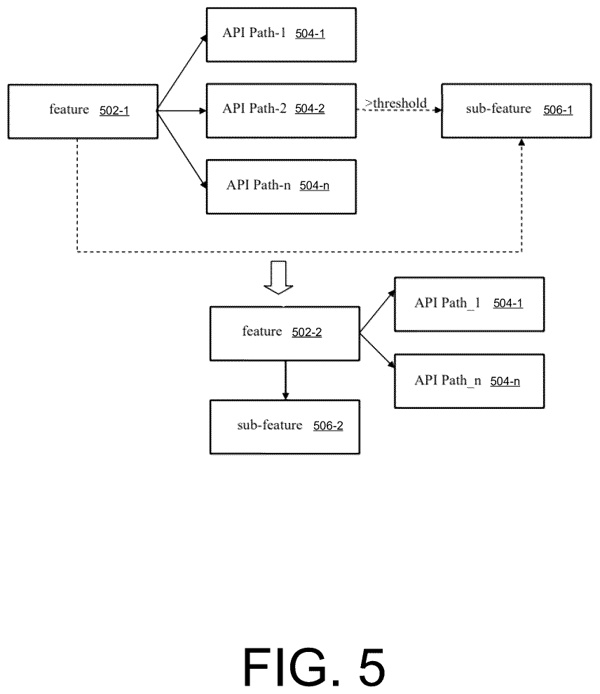

FIG. 5 illustrates a hierarchy wherein a feature is classified into a sub-feature in accordance with the embodiments of the present subject matter. A part discovery module automates the classification of features 502-1 and feature 502-2 into sub-features 506-1 and sub-feature 506-2, as shown in FIG. 5. The features 502-1 and feature 502-2 are hereinafter collectively referred to as features 502 and individually as feature 502. The sub-features 506-1 and sub-feature 506-2 are hereinafter collectively referred to as sub-features 506 and individually as sub-feature 506.

Each feature 506 may comprise a set of API paths comprising API path-1 504-1, API path-2 504-2, . . . . API path-n 504-n. The API path-1 504-1, API path-2 504-2, . . . . API path-n 504-n are hereinafter collectively referred to as API paths 504 and individually as API path 504. The API paths 504 are runnable applications that the customer operates. If such API is recognized as a widely used or most used API 504 from a group of APIs defined under the same parent feature, then such widely recognized API path is defined as sub-features 506, which is another independent part linked to the parent-feature 502. The system monitors API specifications and decisive metrics like the number of occurrences of each API path 504, the relative count of such occurrences in proportion to occurrences of other APIs, as well the frequency of use and the number of times each API provided service to customers; validate these decisive metrics with the preset thresholds; transform the API path 504 into a sub-feature 506 if the decisive metrics of such API path 504 supersede the thresholds and link such sub-feature 506 to the parent feature 502.

In accordance with one of the embodiments, customers can interact with the generated Sub-Features and their links to their parent Features in parts and trails interfaces, where they can take action on the discovered Sub-Feature. Importantly, they can decide if the Sub-Feature is an independent Feature by linking it to a Capability, or they can merge parent Feature properties with the Sub-Feature. This merging will combine the properties of the parent Feature with the Sub-Feature (combining APIs of parent Features into the Sub-Feature's APIs set). The generated Sub-Features and converted Sub-Features into parent Features are stored in a Parts table (wherein the Parts table is a constituent of a database) of the Part Discovery module.

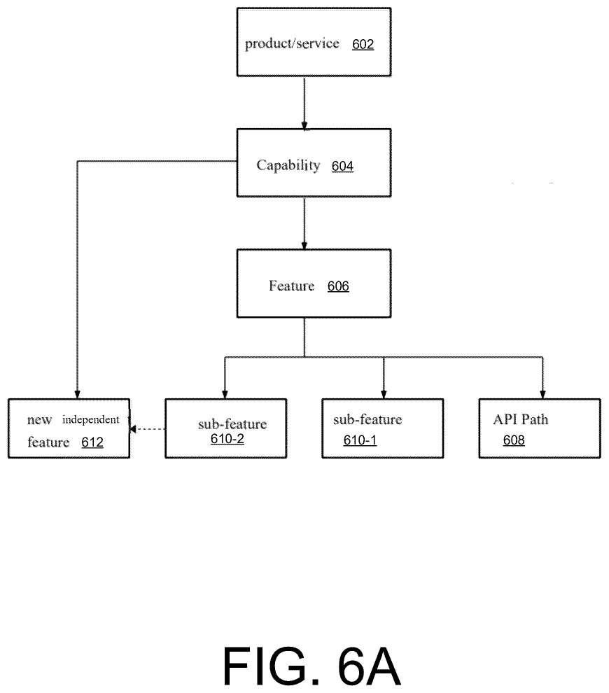

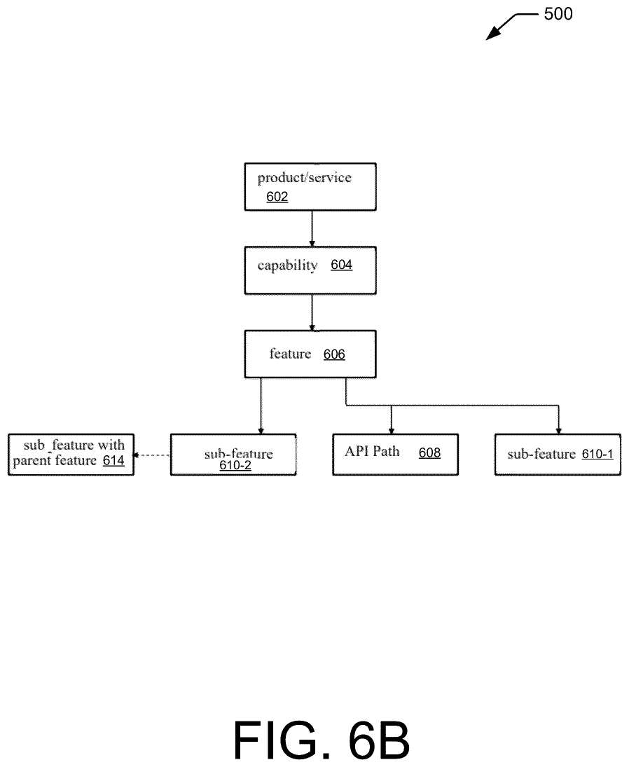

FIG. 6A illustrates a hierarchy wherein a feature is classified into a sub-feature/independent feature in accordance with the embodiments of the present subject matter. FIG. 6B illustrates a hierarchy merge of a parent feature with the sub-feature, in accordance with the embodiments of the present subject matter. For sake of brevity, FIGS. 6A and 6B have been explained in conjunction. In the embodiment disclosed in FIGS. 6A and 6B, a generated Sub-Feature 610 is validated to be an independent Feature after evaluating the independent aspects of such Sub-Feature from a parent Feature 606. The sub-feature 610 may refer to sub-feature 610-1 and sub-feature 610-2 shown in FIGS. 6A and 6B. In this case, the Sub-Feature 610 is transformed into a new independent Feature 612, and it is linked to a higher-tier Part (like Capability) of a product or service hierarchy 604, as shown in FIG. 6A. If the generated Sub-Feature 610 is validated to be an independent Part after computing the independence of API parameters, independence of API calls, or independence of the description of the APIs defined in the description of the Sub-Feature 610, as compared to those of other sections of the same parent Feature 606, then such Sub-Feature 610 is merged with properties of parent Feature 606 properties to generate a Sub-Feature with parent Feature properties 614 as shown in FIG. 6B. The product/service 604 and the capability 606 are similar to the product/service 202 and the capability 204 discussed in relation to FIG. 2.

As discussed in FIGS. 5 to 6B, the system automates the classification of a feature into a sub-feature. As previously discussed, the feature may comprise of a plurality of sub-modules. In an example, the sub-module may have decisive metrics exceeding the predefined threshold values. In such a scenario, the sub-module may be classified as a sub-feature. Further, a hierarchical link is established between the sub-feature and the feature. In an example, the performance and utilization of the sub-feature may be monitored to further re-classify the sub-feature. The re-classification may include at least one of a transformation of the sub-feature into an independent feature and merge of the sub-feature with the feature to create a consolidated feature based on the validation of the sub-feature.

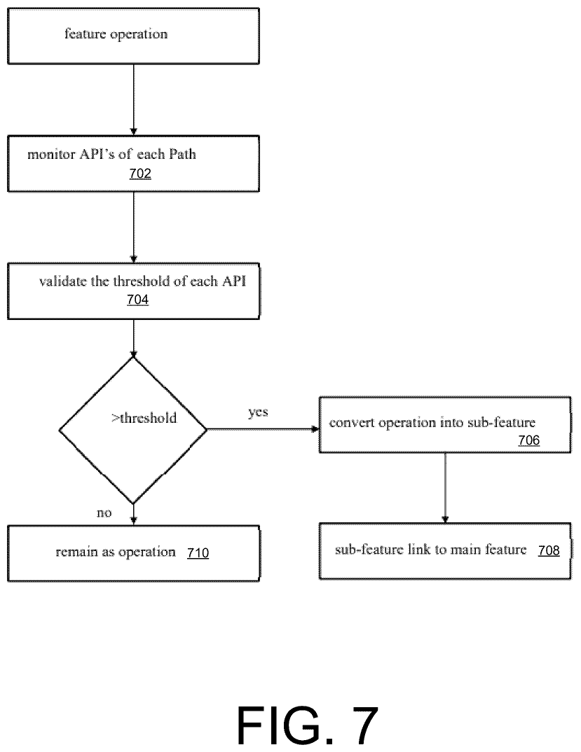

FIG. 7 illustrates a block diagram of a method of generating the sub-feature from a feature in accordance with the embodiments of the present subject matter. A part discovery module enables the generation of sub-features from a parent feature of a capability. Each API specifications of the feature and the decisive metrics like the number of occurrences of each API Part, the relative count of such occurrences in proportion to occurrences of other API paths, as well the frequency of use and the number of times each API provides service to customers are monitored; and validating these decisive metrics with the preset thresholds to transform the API part into a sub-feature if the decisive metrics of such API supersede the thresholds, and linking such sub-feature to the parent feature. The process of generating sub-features includes monitoring the specifications of API, as shown in block 702, and decisive metrics like the number of occurrences of each API path, the relative count of such occurrences in proportion to occurrences of other API paths, as well the frequency of use and the number of times each API provided service to customers, validating these decisive metrics with the threshold determined through contextual or relational or dynamic analysis of each API, as shown in block 704; transforming the API part into a sub-feature if the decisive metrics of such API supersedes the threshold, as shown in block 706; and linking such sub-feature to the parent feature, as shown in block 708. In a situation where the decisive metrics do not validate with the threshold or are less than the threshold, the feature operation remains as an operation, as shown in block 710.

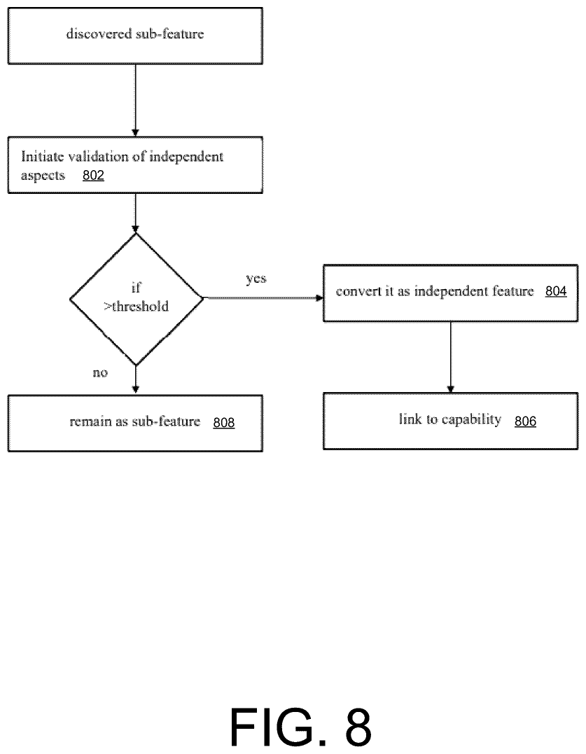

FIG. 8 illustrates a block diagram of a method of determining independent aspects of a sub-feature and transforming it into an independent feature, in accordance with the embodiments of the present subject matter. A parts discovery module transforms the generated sub-feature into an independent feature. Each sub-feature grouped or classified under a feature is monitored for any independence of API parameters, independence of API calls, or independence of the description of the APIs defined in the description of the sub-feature, as compared to those of other sections of the same parent feature. The occurrence of API/usage recorded for each API supersedes the threshold (wherein the threshold is determined through relational analysis). Such a sub-feature is classified as an independent feature and linked to a higher-tier Part (like Capability) of the present product or service hierarchy. The process of transforming a sub-feature into an independent feature includes validating the independent aspects of the generated sub-feature, as shown in block 802; transforming the Sub-Feature into an independent Feature if the decisive metrics like usage of APIs, occurrence of APIs supersedes the threshold (here threshold indicates the relational aspect of the Sub-Feature), as shown in block 804; and linking such independent feature to the capability, as shown in block 806. In a situation where the independent aspects of the discovered sub-feature do not validate with the threshold or are less than the threshold, the feature operation remains a sub-feature, as shown in block 808.

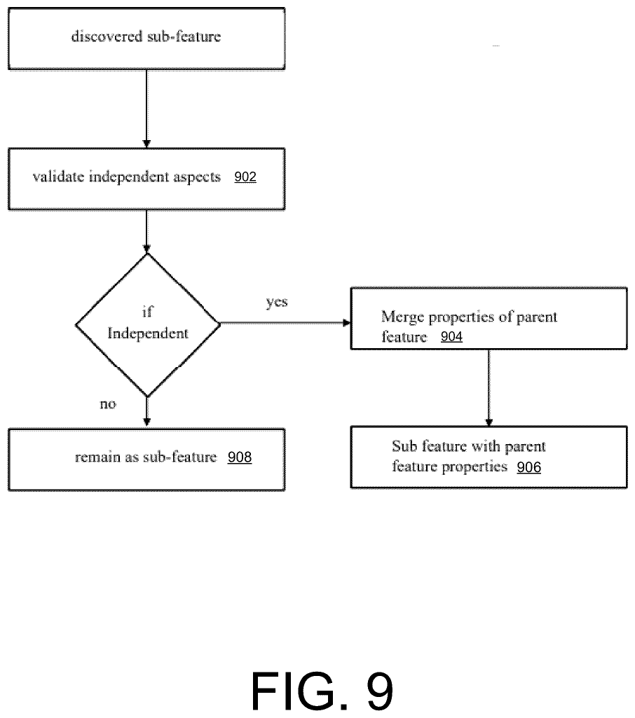

FIG. 9 illustrates a block diagram of a method of merging the parent feature with the sub-feature, in accordance with the embodiments of the present subject matter. A parts discovery module merges the properties or functions of the parent feature into the generated sub-feature. Each sub-feature grouped or classified under a feature is monitored for the independent aspects by validating the independence of API parameters, independence of API calls, or independence of the description of the APIs defined in the description of the sub-feature, as compared to those of other sections of the same parent feature, the number of actions or usage recorded for each API supersedes the threshold (determined through contextual or relational or dynamic analysis) then such sub-feature is merged with parent feature properties to form a sub-feature with properties of parent feature. The merged sub-feature comprises APIs covered by the parent feature with its own set of APIs and any other properties of the parent feature. The process of merging properties or functions of a parent feature with the generated sub-feature include validating the independent aspects of the generated sub-feature, as depicted in block 902; merging properties of the parent feature into the generated sub-feature into an independent feature if the decisive metrics like usage of APIs, the occurrence of APIs supersedes the threshold (here threshold indicates the relational aspect of the sub-feature), as depicted in block 904, thereby generating a sub-feature with parent feature properties, as depicted in block 906. In a situation where the independent aspects of the generated sub-feature do not validate with the threshold or are less than the threshold, the discovered sub-feature remains a sub-feature, as shown in block 908.

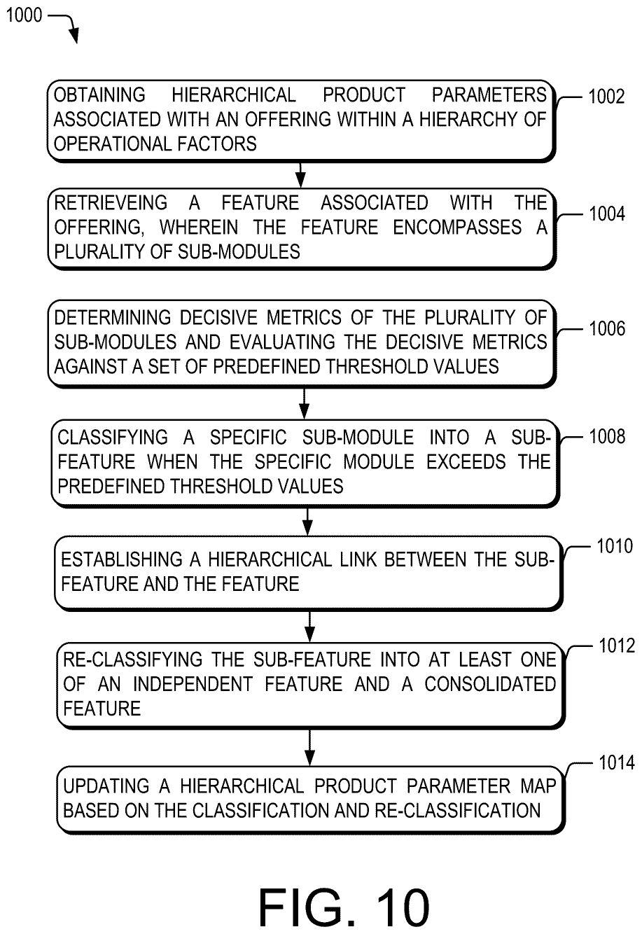

FIG. 10 illustrates a block diagram of a method 1000 for facilitating classification of hierarchical product parameters in a hierarchy of operational factors for an offering, in accordance with an example implementation of the present subject matter. The method 1000 summarizes the processes described in relation to FIGS. 7 to 9. While describing FIG. 10, the term part has been referred to as a hierarchical product parameters and the product/service has been referred to as an offering.

Although the method 1000 may be implemented in a variety of devices, but for the ease of explanation, the description of the method 1000 is provided in reference to the above-described system 104. The order in which the method 1000 is described is not intended to be construed as a limitation, and any number of the described method blocks may be combined in any order to implement the method 1000, or an alternative method.

It may be understood that blocks of the method 1000 may be performed in the system 104. The blocks of the method 1000 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At block 1002, hierarchical product parameters associated with an offering within a hierarchy of operational factors may be obtained. The hierarchical product parameters may include at least one of a capability and a feature. In an example, a product parameter seed may be executable to obtain a hierarchical product parameter for the offering operating in a unified platform. The product parameter seed may be an intermediary memory structure that may be stored, inspected, and retrospected. In an example, the product parameter seeds may be clues. The product parameter seeds may be generated by extracting data from a plurality of connected data sources used in an organization and by converting the extracted data into a standard product parameter seed format.

At block 1004, a feature associated with the offering may be retrieved. The feature may be composed of multiple smaller, modular components, referred to as sub-modules. Each sub-module amongst the plurality of sub-modules represents a set of programming code integrable in a microservice for performing a capability. Further, each sub-module contributes to the overall functionality of the feature, which in turn supports the higher-level capability.

At block 1006, decisive metrics of the sub-modules may be determined. In an example, the decisive metrics may indicate the operational relevance of the sub-modules. In another example, the decisive metrics are quantitative or qualitative measures used to evaluate the importance, performance, or relevance of a sub-module. The decisive metrics may include one or more of a usage frequency, a functional cohesion, an inter-component coupling, and an operational distinctiveness. and retrieved. Once the decisive metrics are determined, the decisive metrics of each sub-module may be evaluated against a set of predefined threshold values to validate the operational relevance of the sub-modules. The predefined threshold values may be determined through at least one of a contextual, relational, and dynamic analysis of the hierarchical product parameters.

Based on the validation, at block 1008, a specific sub-module from the sub-modules may be identified, wherein the specific sub-module may have decisive metrics exceeding the predefined threshold values. The identified specific sub-module may then be classified into a sub-feature. The sub-feature may have unique characteristics or functionality that may clearly differentiate the sub-feature from other sub-modules within the feature.

At block 1010, a hierarchical link may be established between the classified sub-feature and the feature. In an example, the feature may represent a higher-level component, while the sub-feature may be a more specific, lower-level component derived from the feature. Such hierarchical link establishes a parent-child relationship where the feature is the parent, and the sub-feature is the child. This relationship indicates that the sub-feature is a subset or specialized aspect of the broader feature. In an example, a hierarchical product parameter map may be updated to reflect the new relationship, i.e., established hierarchical link between the classified sub-feature and the feature.

At block 1012, the performance and utilization of the sub-features may be monitored. In an example, a performance metric indicating how well the sub-feature is executing its intended functions may be determined and monitored. The performance metric may include response time (indicative of how quickly the sub-feature processes requests), throughput, error rates (frequency of errors or failures), and resource consumption (consumption of CPU, memory, and network). In another example, a utilization metric indicating how frequently and in what ways the sub-feature is being used may be determined. The utilization metric may include usage frequency (indicative of how often the sub-feature is invoked), user engagement (interaction of users with the sub-feature), API call volume (number and types of API calls to the sub-feature), and usage patterns (indicative of when and how the sub-feature is being used).

In an example implementation, based on the monitoring of the performance and utilization of the sub-feature, the sub-feature may be transformed into an independent feature. In another example implementation, based on the monitoring the performance and utilization of the sub-feature, the sub-feature may be merged with the parent feature to create a consolidated feature. The consolidated feature may be created by combining the sub-feature back into its parent feature. This merger may result in a single, more comprehensive feature that incorporates the functionality of both the parent feature and the sub-feature.

At bock 1014, the hierarchical product parameter map may be updated or modified to reflect the changes associated with the re-classification and classification. Keeping the hierarchical product parameter map updated ensures that it accurately reflects the current state of the offering's structure.

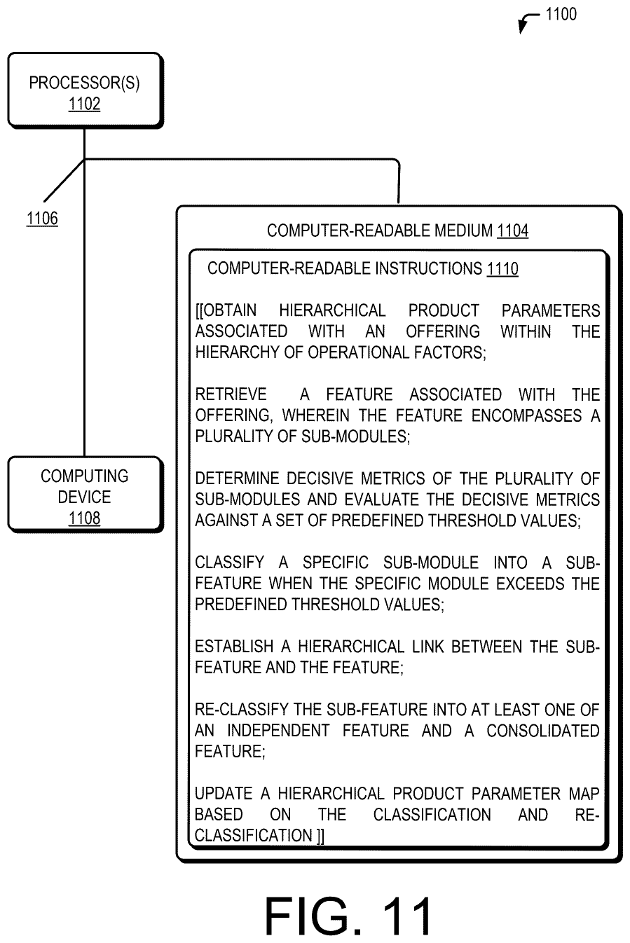

FIG. 11 illustrates a non-transitory computer-readable medium for facilitating classification of hierarchical product parameters in a hierarchy of operational factors for an offering, in accordance with an example of the present subject matter.

In an example, the computing environment 1100 comprises processor(s) 1102 communicatively coupled to a non-transitory computer-readable medium 1104 through communication link 1106. In an example, the computing environment 1100 may be, for example, the system 104. In an example, the processor(s) 1102 may have one or more processing resources for fetching and executing computer-readable instructions 1110 from the non-transitory computer-readable medium 1104. The processor 1102 and the non-transitory computer-readable medium 1104 may be implemented, for example, in the system 104.

The non-transitory computer-readable medium 1104 may be, for example, an internal memory device or an external memory. In an example, the communication link 1106 may be a network communication link, or other communication links, such as a PCI (Peripheral component interconnect) Express, USB-C (Universal Serial Bus Type-C) interfaces, I2C (Inter-Integrated Circuit) interfaces, etc. In an example, the non-transitory computer-readable medium 1104 comprises a set of computer-readable instructions 1110 which may be accessed by the processor 1102 through the communication link 1106 and subsequently executed for facilitating optimization of cellular network performance of the network element. The processor(s) 1102 and the non-transitory computer-readable medium 1104 may also be communicatively coupled to a system 104 over the network.

Referring to FIG. 11, in an example, the non-transitory computer-readable medium 1104 comprises computer-readable instructions 1110 that cause the processor 1102 to obtain hierarchical product parameters associated with an offering within a hierarchy of operational factors. The hierarchical product parameters may include at least one of a capability and a feature. In an example, a product parameter seed may be executable to obtain a hierarchical product parameter for the offering operating in a unified platform. The product parameter seed may be an intermediary memory structure that may be stored, inspected, and retrospected. In an example, the product parameter seeds may be clues.

In an example, the computer-readable instructions 1110 may then cause the processor 1102 to retrieve a feature associated with the offering. The feature may be composed of multiple smaller, modular components, referred to as sub-modules. Each sub-module amongst the plurality of sub-modules represents a set of programming code integrable in a microservice for performing a capability. Further, each sub-module contributes to the overall functionality of the feature, which in turn supports the higher-level capability.

In the example, the instructions 1110 may then cause the processor 1102 to determine decisive metrics of the sub-modules. In an example, the decisive metrics may indicate the operational relevance of the sub-modules. In another example, the decisive metrics are quantitative or qualitative measures used to evaluate the importance, performance, or relevance of a sub-module. The decisive metrics may include one or more of a usage frequency, a functional cohesion, an inter-component coupling, and an operational distinctiveness. and retrieved. Once the decisive metrics are determined, the decisive metrics of each sub-module may be evaluated against a set of predefined threshold values to validate the operational relevance of the sub-modules. The predefined threshold values may be determined through at least one of a contextual, relational, and dynamic analysis of the hierarchical product parameters.

Further, the instructions 1110 may then cause the processor 1102 to identify a specific sub-module from the sub-modules based on the validation. The specific sub-module may have decisive metrics exceeding the predefined threshold values. The identified specific sub-module may then be classified into a sub-feature. The sub-feature may have unique characteristics or functionality that may clearly differentiate the sub-feature from other sub-modules within the feature.

In the example, the instructions 1110 may then cause the processor 1102 to establish a hierarchical link between the classified sub-feature and the feature. The instructions 1110 may cause the processor 1102 to reclassify the sub-feature into at least one of an independent feature and a consolidated feature based on the performance and utilization of the sub-features. Further, the instructions 1110 may cause the processor 1102 to update or modify the hierarchical product parameter map to reflect the changes associated with the re-classification and classification.

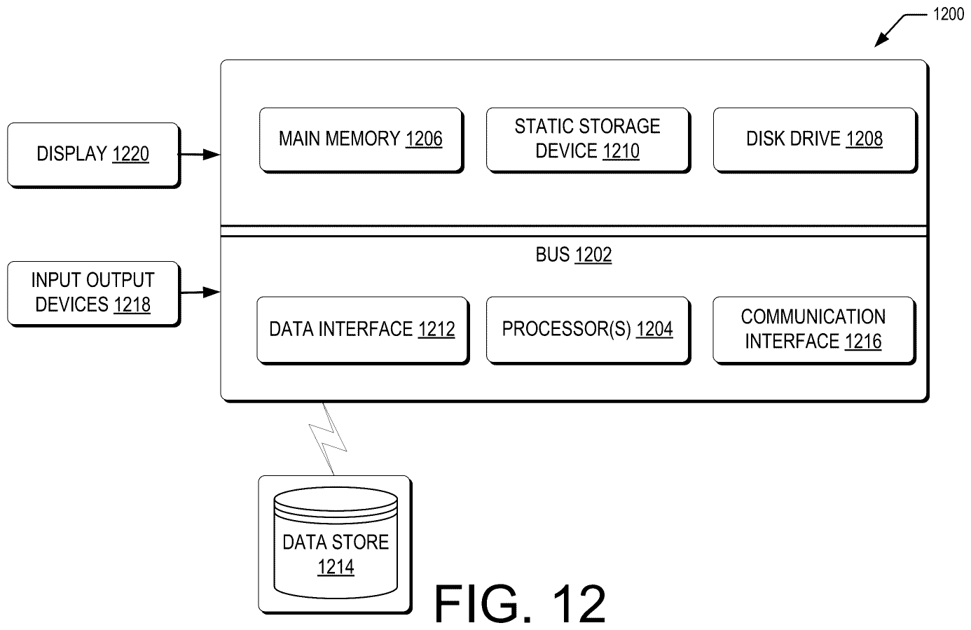

FIG. 12 is a block diagram of an illustrative computing processing system 1200 suitable for implementing an embodiment of the present invention. The computer processing system 1200 comprises a processing unit, a communications interface, and a non-transitory computer-readable storage medium to store instructions, wherein the processing unit executes the stored instructions to perform protocol implementation, internal authorization, handling of the access tokens, revoking of access tokens, validating third-Party services tokens, and refreshing a token. Computer processing system 1200 includes a bus 1202 or another communication mechanism for communicating information, which interconnects subsystems and devices, such as processor(s) 1204, main memory 1206 (e.g., RAM), static storage device 1210 (e.g., ROM), disk drive 1208 (e.g., magnetic, or optical), communication interface 1216 (e.g., modem or Ethernet card), display 1220 (e.g., CRT or LCD), input/output devices 1218 (e.g., keyboard), and cursor control.

According to one embodiment of the invention, computer processing system 1200 performs specific operations by processor(s) 1204 executing one or more sequences of one or more instructions contained in main memory 1206. Such instructions may be read into the main memory 1206 from another computer-readable/usable medium, such as static storage device 1210 or disk drive 1208. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware used to implement all or Part of the invention.

The term “computer-readable medium” or “computer-usable medium,” as used herein, refers to any medium that Participates in providing instructions to processor(s) 1204 for execution. Such a medium may take many forms, including, but not limited to, non-volatile media and volatile media. Non-volatile media includes, for example, optical or magnetic disks, such as disk drive 1208. Volatile media has dynamic memory, such as main memory 1206. A data store 1214 may be accessed in a computer-readable medium (not shown in FIG. 12) using a data interface 1212.

Typical forms of computer-readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip, or cartridge, or any other medium from which a computer can read.

In an embodiment of the invention, execution of the sequences of instructions to practice the invention is executed by a single computer processing system 1200. According to other embodiments of the invention, two or more computer systems 1200 coupled by a communication link (e.g., LAN, PTSN, or wireless network) may perform the sequence of instructions required to practice the invention in coordination.

The computer processing system 1200 may transmit and receive messages, data, and instructions, including program, i.e., application code, through the communication link and a communication interface 1216. Received program code may be executed by processor 1204 as it is received and/or stored in disk drive 1208 or other non-volatile storage for later execution.

In a typical configuration, the computer includes one or more processors (CPU), an input/output interface, a network interface, and a memory. The memory can consist of a non-persistent memory, a random-access memory (RAM), and/or a non-volatile memory in a computer-readable medium, for example, a read-only memory (ROM) or a flash memory (flash RAM). Memory is an example of a computer-readable medium.

Although examples of the present subject matter have been described in language specific to methods and/or structural features, it is to be understood that the present subject matter is not limited to the specific methods or features described. Rather, the methods and specific features are disclosed and explained as examples of the present subject matter

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system for classifying hierarchical product parameters in a hierarchy of operational factors for an offering operating in a unified platform, the system comprising:
a processor to:
obtain the hierarchical product parameters associated with the offering within the hierarchy of operational factors, wherein the hierarchical product parameters include at least one of a feature of the offering;
retrieve the feature associated with the offering, wherein the feature encompasses a plurality of sub-modules, each sub-module amongst the plurality of sub-modules representing a set of programming code integrable in a microservice for performing a capability;
determine decisive metrics of the plurality of sub-modules and evaluate the decisive metrics of each sub-module against a set of predefined threshold values to validate an operational relevance, the operational relevance being indicative of a degree to which a sub-module provides relevant contribution to the functionality of the feature;
identify a specific sub-module within the feature, wherein the specific sub-module has decisive metrics exceeding the predefined threshold values;
classify the identified specific sub-module into a sub-feature, the sub-feature being a distinct and operationally significant subset of the feature;
establish a hierarchical link between the classified sub-feature and the feature;
monitor the performance and utilization of the sub-feature;
cause re-classification of the sub-feature, wherein the reclassification comprises at least one of:
transformation of the sub-feature into an independent feature; and
merge of the sub-feature with the feature to create a consolidated feature;
update a hierarchical product parameter map based on the classification and re-classification.

2. The system of claim 1, wherein the unified platform comprises at least one of a developer-end ecosystem and a user-end ecosystem.

3. The system of claim 1, wherein the hierarchy of operational factors is formed of:
the capability as a sub-unit of the offering, wherein the capability represents functions performed by the offering;
the feature as a sub-unit of the capability, wherein the feature represents an item configurable to perform a capability; and
the microservice as a sub-unit of the feature, the microservice representing an executable piece of a programming file for performing the capability; and
the sub-module as a sub-unit of the microservice;
wherein the hierarchical product parameter comprises at least one of the capability, the feature, the microservice, and the sub-module.

4. The system of claim 1, wherein the decisive metrics comprise one or more of a usage frequency, a functional cohesion, an inter-component coupling, and an operational distinctiveness.

5. The system of claim 4, wherein the usage frequency is indicative of a rate at which the sub-module is utilized, the functional cohesion is a degree to which elements within the sub-module work together to perform a single, well-defined task, the inter-component coupling is indicative of a level of interdependence between different sub-modules, and the operational distinctiveness is indicative of an uniqueness of the sub-module's function compared to other sub-modules of the plurality of sub-modules.

6. The system of claim 1, wherein the predefined threshold values are determined through at least one of a contextual, relational, and dynamic analysis of the hierarchical product parameters.

7. The system of claim 1, wherein to transform the sub-feature into the independent feature, the processor is to:
determine independent aspects of the sub-feature;
transform the sub-feature into the independent feature based on a validation of the determined independent aspects; and
link the independent feature to a higher-tier hierarchical product parameter in the hierarchy of operational factors.

8. The system of claim 1, wherein to create a consolidated feature, the processor is to:
determine independent aspects of the sub-feature; and
merge properties of the feature into the sub-feature to form the consolidated feature based on a validation of the determined independent aspects.

9. The system of claim 1, wherein the offering operating in the unified platform comprises at least one of a product and a service.

10. A method for classifying hierarchical product parameters in a hierarchy of operational factors for an offering operating in a unified platform, the method comprising:
obtaining the hierarchical product parameters associated with the offering within the hierarchy of operational factors, wherein the hierarchical product parameters include at least one of a feature of the offering;
retrieving the feature associated with the offering, wherein the feature encompasses a plurality of sub-modules, each sub-module amongst the plurality of sub-modules representing a set of programming code integrable in a microservice for performing a capability;
determining decisive metrics of the plurality of sub-modules and evaluating the decisive metrics of each sub-module against a set of predefined threshold values to validate an operational relevance, the operational relevance being indicative of a degree to which a sub-module provides relevant contribution to the functionality of the feature;
identifying a specific sub-module within the feature, wherein the specific sub-module has decisive metrics exceeding the predefined threshold values;
classifying the identified specific sub-module into a sub-feature, the sub-feature being a distinct and operationally significant subset of the feature;
establishing a hierarchical link between the classified sub-feature and the feature;
monitoring the performance and utilization of the sub-feature;
causing re-classification of the sub-feature, wherein the reclassification comprises at least one of:
transforming the sub-feature into an independent feature; and
merging the sub-feature with the feature to create a consolidated feature;
updating a hierarchical product parameter map based on the classification and re-classification.

11. The method of claim 10, wherein the hierarchy of operational factors is formed of:
the capability as a sub-unit of the offering, wherein the capability represents functions performed by the offering;
the feature as a sub-unit of the capability, wherein the feature represents an item configurable to perform a capability; and
the microservice as a sub-unit of the feature, the microservice representing an executable piece of a programming file for performing the capability; and
the sub-module as a sub-unit of the microservice;
wherein the hierarchical product parameter comprises at least one of the capability, the feature, the microservice, and the sub-module.

12. The method of claim 10, wherein the decisive metrics comprise one or more of a usage frequency, a functional cohesion, an inter-component coupling, and an operational distinctiveness.

13. The method of claim 10, wherein the usage frequency is indicative of a rate at which the sub-module is utilized, the functional cohesion is a degree to which elements within the sub-module work together to perform a single, well-defined task, the inter-component coupling is indicative of a level of interdependence between different sub-modules, and the operational distinctiveness is indicative of an uniqueness of the sub-module's function compared to other sub-modules of the plurality of sub-modules.

14. The method of claim 10, wherein to transform the sub-feature into the independent feature, the method comprising:
determining independent aspects of the sub-feature;
transforming the sub-feature into the independent feature based on a validation of the determined independent aspects; and
linking the independent feature to a higher-tier hierarchical product parameter in the hierarchy of operational factors.

15. The method of claim 10, wherein to create a consolidated feature, the method comprising:
determining independent aspects of the sub-feature; and
merging properties of the feature into the sub-feature to form the consolidated feature based on a validation of the determined independent aspects.

16. A non-transitory computer-accessible storage medium storing program comprising instructions for classification of hierarchical product parameters in a hierarchy of operational factors for an offering operating in a unified platform, the instructions being executable by a processor to:
obtain the hierarchical product parameters associated with the offering within the hierarchy of operational factors, wherein the hierarchical product parameters include at least one of a feature of the offering;
retrieve the feature associated with the offering, wherein the feature encompasses a plurality of sub-modules, each sub-module amongst the plurality of sub-modules representing a set of programming code integrable in a microservice for performing a capability;
determine decisive metrics of the plurality of sub-modules and evaluate the decisive metrics of each sub-module against a set of predefined threshold values to validate an operational relevance, the operational relevance being indicative of a degree to which a sub-module provides relevant contribution to the functionality of the feature;
identify a specific sub-module within the feature, wherein the specific sub-module has decisive metrics exceeding the predefined threshold values;
classify the identified specific sub-module into a sub-feature, the sub-feature being a distinct and operationally significant subset of the feature;
establish a hierarchical link between the classified sub-feature and the feature;
monitor the performance and utilization of the sub-feature;
cause re-classification of the sub-feature, wherein the reclassification comprises at least one of:
transformation of the sub-feature into an independent feature; and
merge of the sub-feature with the feature to create a consolidated feature;
update a hierarchical product parameter map based on the classification and re-classification.

17. The non-transitory computer-accessible storage medium of claim 16, wherein the decisive metrics comprise one or more of a usage frequency, a functional cohesion, an inter-component coupling, and an operational distinctiveness.

18. The non-transitory computer-accessible storage medium of claim 16, wherein to transform the sub-feature into the independent feature, the instructions cause the processor to:
determine independent aspects of the sub-feature;
transform the sub-feature into the independent feature based on a validation of the determined independent aspects; and
link the independent feature to a higher-tier hierarchical product parameter in the hierarchy of operational factors.

19. The non-transitory computer-accessible storage medium of claim 16, wherein to create a consolidated feature, the instructions cause the processor to:
determine independent aspects of the sub-feature;
transform the sub-feature into the independent feature based on a validation of the determined independent aspects; and
link the independent feature to a higher-tier hierarchical product parameter in the hierarchy of operational factors.

20. The non-transitory computer-accessible storage medium of claim 16, wherein the offering operating in the unified platform comprises at least one of a product and a service.
